(19) United States
(12) Patent Application Publication
(10) Pub. No.: US 2008/0097969 A1
(43) Pub. Date: Apr. 24, 2008

(54) Method for Providing Search Service and System for Executing the Method

(75) Inventors: Woo Sung Lee, Seoul (KR); Ra Young Yang, Seoul (KR); Jun Seok Na, Seoul (KR)

Correspondence Address: BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 11/720,193

(22) PCT Filed: Nov. 29, 2005
(86) PCT No.: PCT/KR05/04045

§ 371 Date: May 24, 2007

(30) Foreign Application Priority Data
Nov. 29, 2004 (KR) 10-2004-0098598

(51) Int. Cl. G06F 17/30

(52) U.S. Cl. 707/3; 707/E17.108

(57) ABSTRACT

The search service providing method according to the presents invention, includes maintaining a search result database including a keyword, a search listing associated with the keyword, a bid amount associated with the search listing, a total exposure number associated with the search listing, an exposure index associated with the search listing, and/or an advertiser identifier associated with the search listing; in the case a search request including a predetermined keyword is inputted from a user, selecting a predetermined number of search listings whose exposure index ranks high from search listings associated with the keyword; and generating and providing a search result list including the selected predetermined number of the search listings, wherein the exposure index is computed based on an average click rate that is an average of unit period click rates for a specified period.

### TECHNICAL FIELD

The present invention relates to a method of providing search services and a search system executing the method, and more particularly, to a method of selecting search results based on an average click rate and a bid amount of each search result and a search result system executing the method.

### BACKGROUND ART

Currently, a search system providing search services not only provides a search result according to a search request of a user but also provides a so-called “keyword advertisement services” in which, as a cost of providing the search result to the user or selecting the provided search result by the user, a predetermined advertisement cost is charged to an advertiser registering the search result.

On the other hand, in order to generate a predetermined advertisement effect in which a search result of an advertiser is exposed to a user, the user recognizes the search result or selects the search result to move to a web page associated with the advertiser, the search result of the advertiser may be arranged in a position and a form that the user can easily recognize in a search result page.

Since there is an enormous amount of information capable of being searched on the Internet, a number of search results provided according to a search request of a user can only increase. Accordingly, a case in which a list of search results according to a search request reaches several tens of pages often occurs. Therefore, an advertiser desires that the advertiser's own search result is provided at the top of a list of search results, or in a more distinctive form. Hereinafter, a search result list designates a list of search results provided in a position higher than others or in a more distinctive form.

However, in the case a plurality of search results is registered for a keyword advertisement with respect to a keyword, it is impossible or unsuitable to provide the entire plurality of the search results in the top or in a distinctive form. Accordingly, a search system has to perform a process of selecting search results included in the search result provided by the keyword advertisement service from the search results registered with respect to the keyword.

Korean Patent Laid-Open No. 2002-0019042 discloses a configuration in which a search system arranges search results according to a bid amount registered by an advertiser to provide to a user requesting a search in the case of providing keyword advertisement services. Namely, the search system provides a list, in a form in which a search result having a bid amount higher than other search results is arranged at the top, to the user. Namely, the search system providing keyword advertisement services according to a conventional technology selects search results to be included in a search result list, based on the bid amount.

On the other hand, a configuration is known in which search results are selected and provided according to the degree of association or preference between a keyword requested by a user and search results to be provided corresponding to the search request in a search system not providing keyword advertisement services.

There are many known methods of measuring the degree of association or preference between a keyword and a search result or a keyword and information provided in association with a search result. One of the methods is to measure according to how many users select a search result provided according to a search request. Namely, the search result selected by many users may have a high degree of association or preference in association with the keyword.

However, the described degree of association or preference is an element difficult to be included in keyword advertisement services charging an advertisement cost to an advertiser as a cost of being included in the search result list and provided to users. Accordingly, in the case of providing keyword advertisement services, the search system according to the conventional technology can only select a search result included in the search result list depending on a bid amount.

On the other hand, in the case a provided search result included in the search result list to be well recognized does not correspond to desired information or does not sufficiently provide desired information, there is a danger of reducing reliability with respect to a search system providing search service.

Accordingly, NHN Inc. that is the applicant of the present invention and provides search services including keyword advertisement services in the web page naver, www.naver.com, has invented a method of selecting search results included in a search result list by considering not only a bid amount but also how many users select the search result, namely, a click rate that is a ratio of a number of times in which a predetermined search result is provided to users and a number of times in which the provided search result was selected by the users.

However, as a result of the applicant's experiments by using a database populated in a process of providing keyword advertisement services to the web page, in the case only the click rate is used in a process of selecting a search result, search results included in the search result list may change dramatically.

Namely, since the click rate is determined according to selection of the users, in comparison with the bid amount, fluctuation is great according to a period of time, a time of day, whether there is a related a social issue, or with no special cause. There is a problem in that it is difficult to estimate what search result will be included in the search result list, which is different from the conventional technology that only considers the bid amount, as a case in which a search result is selected in one instance but not selected in another.

If the described problem is not solved, since an advertiser cannot estimate whether the advertiser's search result is selected by controlling the bid amount, it is difficult to determined how much the proper bid amount is to find the same search result again because a user receives a different search result whenever searching.

Accordingly, the applicant of the present invention developed a search service providing method and a search system executing the method, which can solve the problem of severe fluctuation of search results included in the search result list, varying with a change in click rates, in which, in order to include a search result in a search result list, a bid amount meeting a purpose what it was provided to do of keyword advertisement services is reflected, and in order to provide a search result that is deemed to be associated with a keyword to users, a click rate is reflected.

### DISCLOSURE OF INVENTION

Technical Goals

To improve the described conventional technology, the present invention provides a search service providing method and search system which select a search result by considering a bid amount associated with a search result and an average click rate computed with respect to the search result.

The present invention also provides a search service providing method and search system which select a search result based on a bid amount and an average click rate, thereby guaranteeing quality of a search result provided according to a keyword advertisement service.

The present invention also provides a search service providing method and search system which select a search result by using an average click rate whose variance is smaller than a click rate so that an advertiser may estimate what search result is selected.

The present invention also provides a search service providing method and search system which provide a basis for determining whether a search result is provided to a user in the case it is difficult to use an average click rate as valid data because the search result is not sufficiently provided to a user from a point in time an advertiser registers the search result to a present point in time or because a period from the point in time the search result is registered to the present point in time is short.

The present invention also provides a search service providing method and search system which determine a value of M according to a number of times of inputting a keyword to compute an average click rate and compute an average click rate by reflecting a click rate of a unit period whose number of exposures, for example, a number of providing a search result, is not less than the value of M, thereby better guaranteeing a smaller variance.

Technical Solutions

To achieve the goals and solve the problems of the described conventional technology, according to an aspect of the present invention, there is provided a method of providing search services in a search system, including: maintaining a search result database including a keyword, a search result associated with the keyword, a bid amount associated with the search result, a total exposure number associated with the search result, an exposure index associated with the search result, and/or an advertiser identifier associated with the search result; in the case a search request including a predetermined keyword is inputted from a user, selecting a predetermined number of search results whose exposure index ranks high from search results associated with the keyword; and generating and providing a search result list including the selected predetermined number of the search results, wherein the exposure index is computed based on an average click rate that is an average of unit period click rates for a certain period from a point in time in the past to a present point in time and the unit period click rate is computed according to a unit period, the unit period click rate is a ratio of a number of clicks of selecting the provided search result by the user to a number of impressions and is computed for each unit period.

The operation of maintaining the search result database may include: (1) computing the total exposure number which is a number of times a predetermined search result is provided to the user from a registration point in time to the present point in time, the registration point in time is a point in time the search result is recorded in the search result database; (2) in the case the total exposure number of the search result is not less than a predetermined reliable exposure number, computing the average click rate from each search result; (3) computing the exposure index with respect to the search result based on the computed average click rate and the bid amount associated with the search result; (4) in the case the total exposure number of the search result is less than the reliable exposure number, computing the exposure index with respect to the search result based on the bid amount associated with the search result and a predetermined basic click rate; and (5) recording the total exposure number and the computed exposure index in the search result database in association with the search result.

The reliable exposure number may be determined by performing the operations of: computing unit period input times which is a number of times a keyword associated with the search result is inputted for unit period; computing an average input value with respect to the search result, which is an average value of unit period input times for a second period from a point in time in the past to the present point in time; and designating the average input value as the reliable exposure number with respect to the search result. The (2) may include the operation of determining whether the total exposure number of the search result is not less than the reliable exposure number associated with the search result.

### BRIEF DESCRIPTION OF DRAWINGS

FIG. 1 is a diagram illustrating network connection of a search system according to an embodiment of the present invention;

FIG. 2 is a flowchart illustrating a search service providing method according to an embodiment of the present invention;

FIG. 3 is a block diagram illustrating a search system illustrating a search system according to another embodiment of the present invention;

FIG. 4 is a diagram illustrating a process of constructing a search result database in an embodiment of the present invention;

FIG. 5 is a diagram illustrating an example of a data structure included in the search result database employed according to an embodiment of the present invention;

FIGS. 6 and 7 are diagrams illustrating tables in which a click rate with respect to a predetermined search result for a single day, with respect to a search result associated with a predetermined keyword;

FIG. 8 is a diagram illustrating a table including an example of an exposure index, a bid amount, an advertisement execution amount, and a time of registration with respect to a predetermined search result in order to explain the present invention; and

FIG. 9 is an internal block diagram illustrating a general use computer apparatus capable of being employed in executing the search service providing method according to the present invention.

### BEST MODE FOR CARRYING OUT THE INVENTION

Hereinafter, the present invention will be described in detail with reference to the attached drawings.

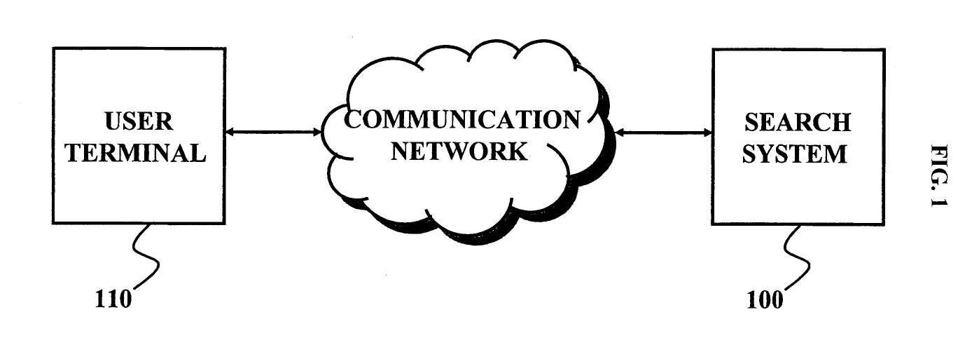

FIG. 1 is a diagram illustrating network connection of a search system 100 according to an embodiment of the present invention. The search system 100 maintains a search result for each keyword in a predetermined search result database and transmits a search result list including search result corresponding to the keyword to a user terminal 110 in the case a search request with respect to the keyword is inputted from the user terminal 110.

A user may input a search request to the search system 100 by using the user terminal 110 and may receive a search result list corresponding to the search request. The user terminal 110 designates a communication terminal such as a personal digital assistant (PDA), a smart phone, a handheld PC, and a mobile phone, which can access the search system 100 via wired or wireless communication network by including a predetermined communication module such as a code division multiple access (CDMA) module, a Bluetooth module, an infrared communication module (IrDA), and a wired/wireless LAN card.

The search system 100 according to the present invention determines what search result is selected to be provided or is arranged in a first scene of a search result web page, according to 1) a bid amount presented by an advertiser and 2) an exposure index computed based on an average click rate, with respect to each search result corresponding to a keyword.

Also, the search system 100 uses a basic click rate instead of the average click rate in the case a period from the point in time the search result is registered to a present point in time is less than a predetermined amount of time or a number of times the search result is provided to the users from the point in time the search result is registered to the present point in time is less than a predetermined number. Namely, the search system 100 may determine what search result is selected and provided from a plurality of search results corresponding to a keyword or what search result is arranged in a first view of a search result web page, according to i) a bid amount submitted by an advertiser, and ii) an exposure index computed based on an average click rate with respect to each of the search results corresponding to the keyword.

The bid amount indicates a maximum cost that the advertiser will pay for an advertisement cost in the case a search result of the advertiser is provided to a user in association with a predetermined keyword and the user selects the search result. The average click rate and the basic click rate will be described in detail with respect to each embodiment.

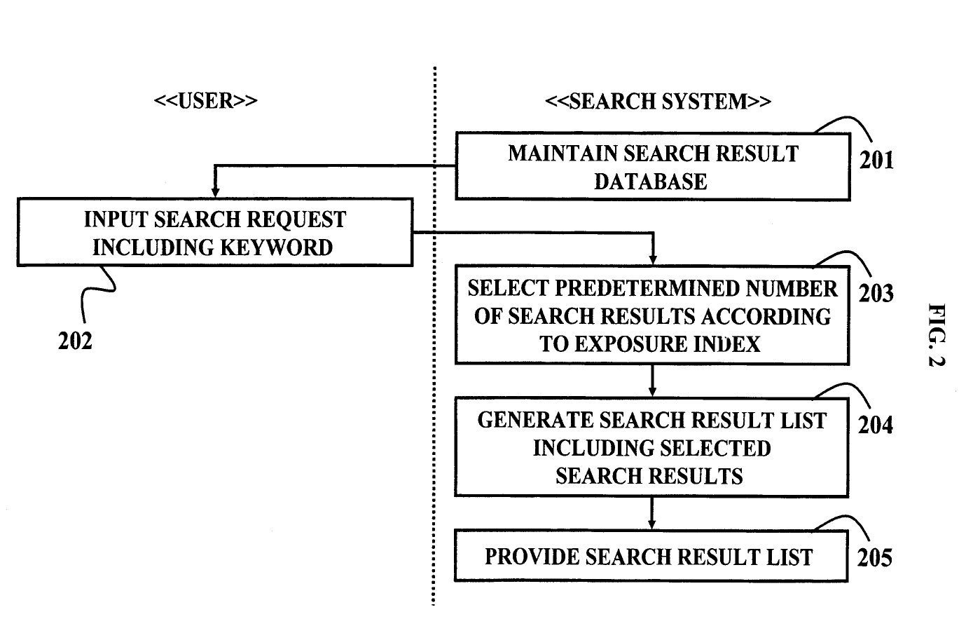

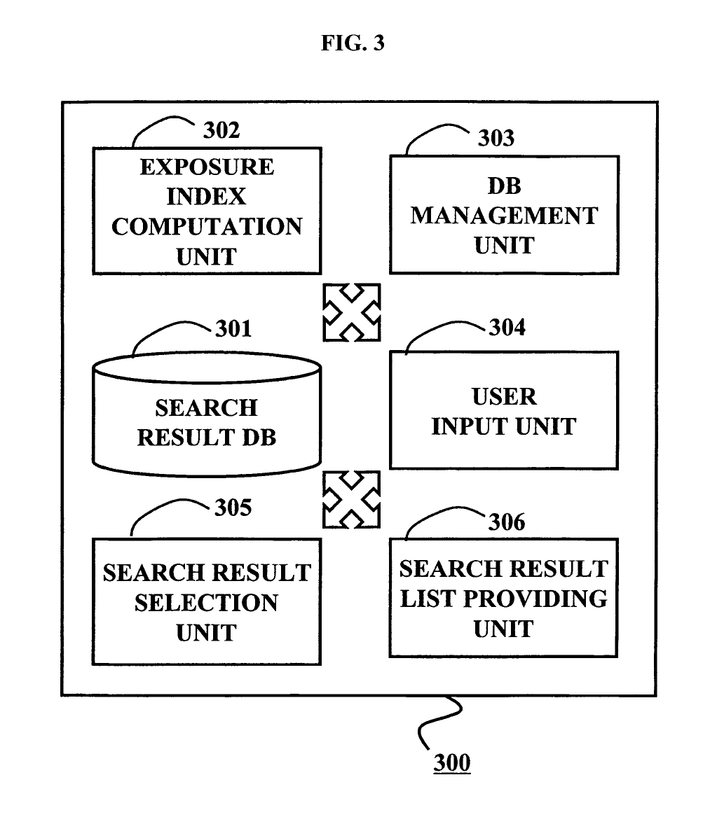

Hereinafter, a search service providing method according to an embodiment of the present invention will be described with reference to FIG. 2. Also, the search service providing method may be performed by a search system 300 illustrated in FIG. 3.

In Step 201, the search system 300 maintains a search result database 301 including a keyword, a search result associated with the keyword, a bid amount associated with the search result, an exposure index associated with the search result, and/or an advertiser identifier associated with the search result.

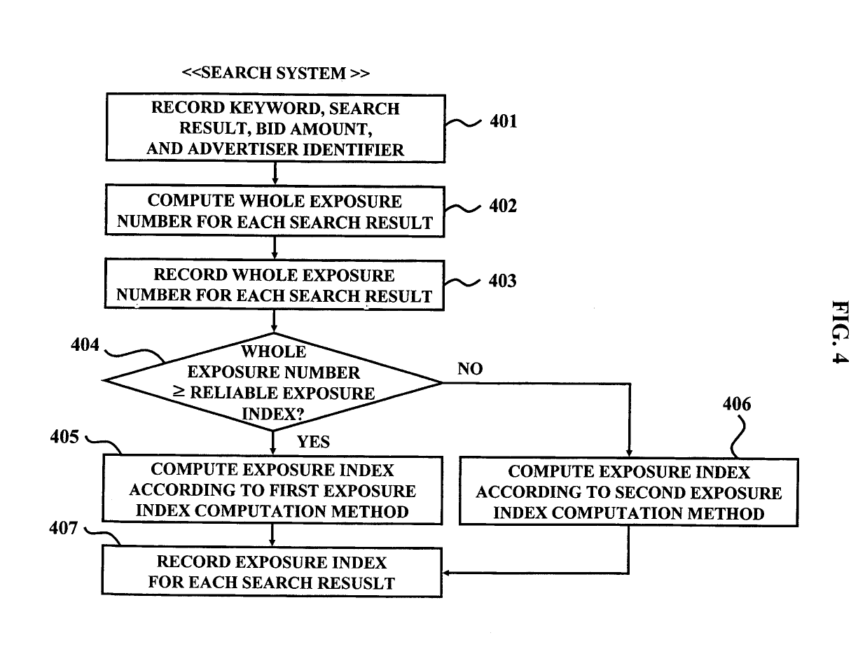

Referring to FIG. 4, the process of maintaining the search result database 301 will be described in detail.

In Step 401, in the case an advertiser requests to register a search result with respect to a predetermined keyword, a database management unit 303 records the search result in the search result database 301 in association with the keyword. Also, the database management unit 303 further records an advertiser identifier for identifying the advertiser and a bid amount presented by the advertiser in the search result database 301 in association with the search result.

In Step 402, an exposure index computation unit 302 computes a total number of exposures from the point in time of registering a search result to a present point in time, for each search result.

In the present specification, the terminology of ‘number of exposures’ indicates a number of times of providing a predetermined search result to a user according to keyword advertisement services.

Generally, a registration point in time indicates a point in time of registering a search result by being recorded in the search result database 301 according to a registration request in the case an advertiser requests to register the search result to be exposed with respect to a predetermined keyword in order to use keyword advertisement services. However, the registration point in time of a search result is not precisely determined and may be determined as from a point in time of requesting to register through a point in time that the search result is recorded in the search result database 301 and actually provided via the keyword advertisement services, by an administrator.

Also, the search system 300 may compute the total number of exposures in real time by increasing the total number of exposures by one whenever the search result is exposed. Also, the search system 300 may periodically sum the total number of exposures by adding a number of exposures for a predetermined period to the total number of exposures.

In Step 403, the database management unit 303 records the computed total number of exposures in the search result database 301 in association with the search result.

In Step 404, the exposure index computation unit 302 determines whether the computed total number of exposures is not less than a predetermined reliable exposure number.

As described later, in the present invention, an exposure index is computed for each search result and whether the search result is included in a search result list is determined based on the exposure index. For example, the search system 300 may generate a search result list including a predetermined number of search results whose exposure index ranks high.

In the present invention, the reliable exposure number is a basis for determining by what method the exposure index associated with the search result is computed. Namely, in the case the total number of exposures is not less than the reliable exposure number, the exposure index of the search result is computed by a first exposure index computation method described later, and in the case the total number of exposures is less than the reliable exposure number, the exposure index of the search result is computed by a second exposure index computation method to be described later.

According to an embodiment of the present invention, the reliable exposure number is determined differently for each keyword. For example, with respect to search results registered in association with a keyword “flower delivery”, the reliable exposure number may be determined to be 100, and with respect to search results registered in association with a keyword “patent”, the reliable exposure number may be determined to be 30. As described later, since the reliable exposure number is a type of a critical value, a proper exposure index may be computed by adaptively determining the reliable exposure number for each keyword. For each search result, the exposure index computation unit 302 may compare a reliable exposure number designated for a keyword associated with the search result with the total exposure number of the search result.

Also, according to another embodiment of the present invention, the reliable exposure number may be designated as an average of a number of times of inputting the keyword for unit period for a predetermined period based on a present point in time. For example, the predetermined period may be determined as “the past 30 days” from the present point in time and the unit period may be determined to be “one day”. The exposure index computation unit 302 may compute a daily average number of inputs for the past 30 days for each keyword and may determine the computed value to be the reliable exposure number. The number of inputs of a keyword indicates a number of times a user inputs a search request including the keyword to the search system 300.

In the case the total number of exposures is not less than the reliable exposure number, in Step 405, the exposure index computation unit 302 computes an exposure index associated with the search result according to the first exposure index computation method.

Also, in the case the total exposure number is less than the reliable exposure number, in Step 406, the exposure index computation unit 302 computes an exposure index associated with the search result according to the second exposure index computation method. Detailed description on the first exposure index computation method and the second exposure index computation method will be described later.

In Step 407, the exposure index computation unit 302 records the computed exposure index in the search result database 301 in association with the search result.

Also, the exposure index computation unit 302 may compute and update the exposure index whenever a reason for change of the exposure index occurs or may periodically compute and update the exposure index.

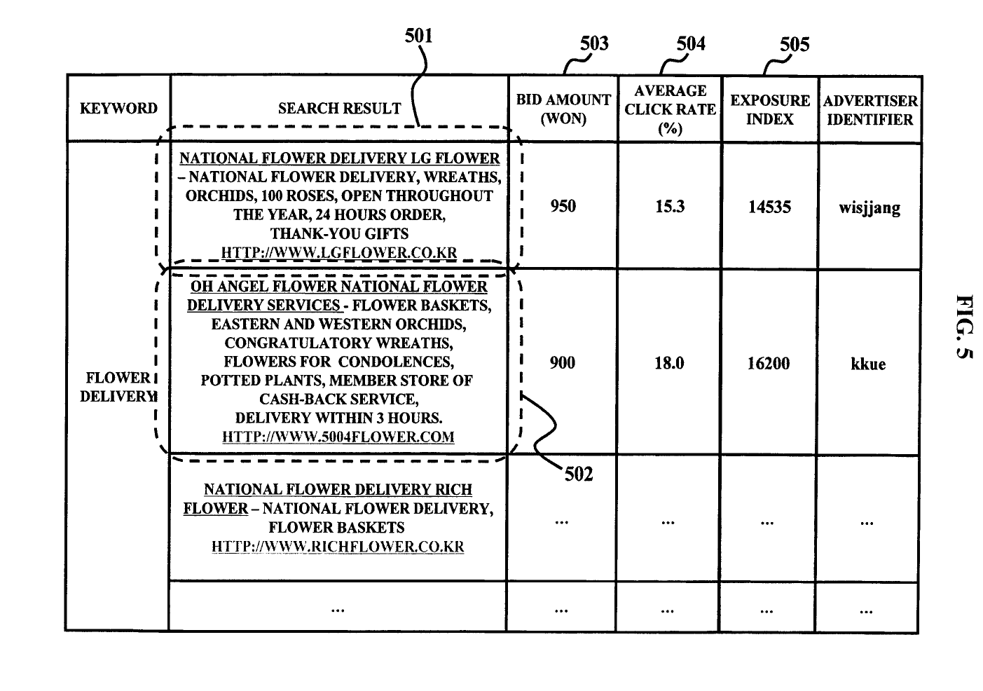

FIG. 5 is a diagram illustrating an example of data recorded in the search result database 301 populated in performing Steps 401 through 407, as described above. The search result recorded in the search result database 301 is information provided to a user according to a search request and includes link information to a predetermined web page to be used as information to provide a link to the web page.

Hereinafter, a process of computing an exposure index according to the first exposure index computation method and a process of computing an exposure index according to the second exposure index computation method will be described in detail.

(1) The Case of Computing an Exposure Index According to the First Exposure Index Computation Method

In the case the total exposure number of the search result is not less than the reliable exposure number, the exposure index computation unit 302 computes an average click rate for each search result. The average click rate is an average of unit period click rates for a certain past period based on a present point in time. Hereinafter, a case of selecting 1 day as a unit period will be described. This is just an example, and the unit period may be randomly, empirically, statistically, or diversely determined by an administrator of the search system 100, such as, for example, 1 hour, 10 hours, or 2 days.

The click rate may be computed by dividing a number of clicks by a number of exposures. The number of exposures indicates the number of times a predetermined search result is provided to a user according to keyword advertisement services, and the number of clicks indicates the number of times the provided search result is selected by the user.

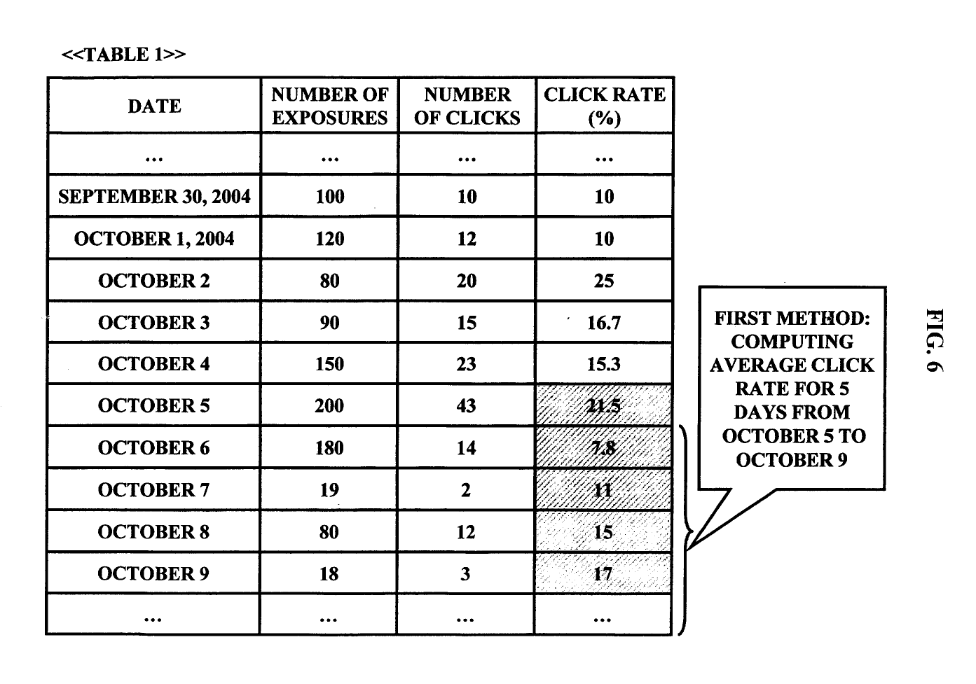

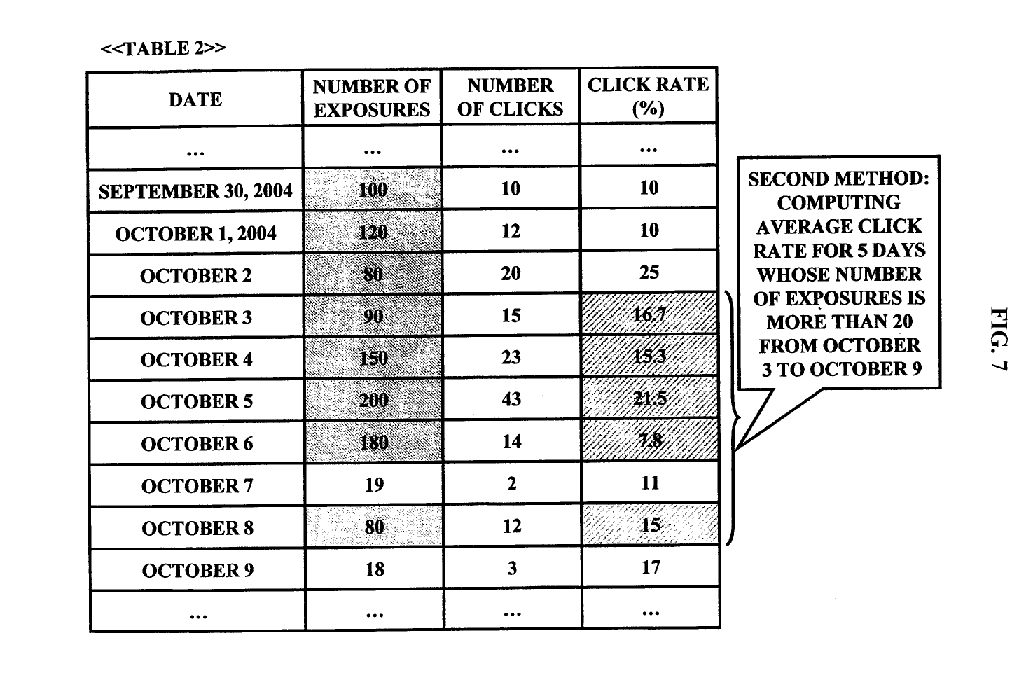

The average click rate may be computed differently according to the certain period. Hereinafter, a process of computing the average click rate will be described with reference to FIGS. 6 and 7.

1) A Case of Computing an Average Click Rate According to a First Method

In Table 1 of FIG. 6, with respect to a search result associated with a predetermined keyword, a click rate of a predetermined search result for each day is recorded. For example, in Table 1, a click rate with respect to a search result 501 for each day is computed in association with a keyword “flower delivery”.

In the first method, a certain continuous period elapsing immediately before a present point in time is determined to be the certain period. Referring to Table 1, if a present point in time is 10 o'clock, Oct. 10, 2004, sequential days previous to the present time, for example, a continuous period from 0 o'clock, Oct. 5, 2004 to 24 o'clock, Oct. 9, 2004 may be determined to be the certain period.

Accordingly, when click rates inputted everyday from 0 o'clock, Oct. 5, 2004 to 24 o'clock, Oct. 9, 2004 are added and divided by 5 days, the average click rate may be computed. Referring to Table 1, an average click rate with respect to the search result 501 is as shown below.

$$\begin{matrix}Average click rate of \\ search result 501\end{matrix} = \frac{( \begin{matrix}21.5 + 10.6 + \\ 5.3 + 15 + 15\end{matrix} ) ( \% )}{5 ( days )} \approx 13.5$$

2) A Case of Computing an Average Click Rate According to a Second Method

In the second method, the sum of a predetermined N unit periods is determined to be the certain period. The N unit periods, namely, N days, may not be continuous, which is different from the first method. According to the second method, the exposure index computation unit 302 identifies N days whose number of exposures for a day is not less than M, for example, 5 days, in the order of closest to a present point in time.

If a value of M is 20, there are slant lines for days whose number of exposures is not less than 20, in Table 2 of FIG. 7. For example, there is Oct. 8, 2004 in which 80 exposures are inputted.

The exposure index computation unit 302 may identify 5 days whose number of exposures is not less than 20, in reverse order of the flow of time from the present point in time, 10 o'clock, Oct. 31, 2004. The search system 100 adds each click rate of the identified days and divides the sum by 5, thereby computing the average click rate. Referring to Table 2, the average click rate of the search result 501 is as shown below.

$$\begin{matrix}Average click rate of \\ search result 501\end{matrix} = \frac{( \begin{matrix}16.7 + 15.3 + \\ 21.5 + 7.8 + 15\end{matrix} ) ( \% )}{5 ( days )} \approx 15.3$$

On the other hand, in the present embodiment, for convenience of description, though a relatively short average click rate of 5 days is computed, the administrator of the search system 300 may determine what length of time is used to compute the average click rate, namely, what the certain period is determined to be, by using an empirical or statistical method. For example, the exposure index computation unit 302 may compute the average click rate for 30 days elapsing immediately before a present point in time.

Also, according to another embodiment of the present invention, M may be determined for each keyword by reflecting a number of times of inputting the keyword. The input number of the keyword, which is a number of times that users input the keyword, may reflect popularity of the keyword. For example, the search system 300 may compute an average of a number of times of inputting the keyword for a certain continuous period elapsing immediately before a present point in time, for each unit period and may determine the value of M as a proportion of the average for each of the unit periods. In order to distinguish the certain period determined for computing the average click rate and the certain period determined for computing the average of the number of times of inputting the keyword for each unit period, hereinafter, the latter is designated as a second period. The second period may be selected by the administrator of the search system 300 and may be selected by considering the certain period, N days, determined for computing the average click rate.

For example, in the case the second period is determined to be 30 days, if the keyword “flower delivery” is inputted a total of 3000 times from the users in past 30 days, an average of the number of times of inputting the keyword “flower delivery” for unit period is computed as 3000÷30=100.

The exposure index computation unit 302 may compute M for each keyword as a proportion of the daily average of the number of times of inputting the keyword “flower delivery” for 30 days. For example, M may be computed as shown below.
M associated with keyword “flower delivery”=20% of daily average of the number of times of inputting keyword “flower delivery” for 30 days=100×20%=20

Namely, with respect to the search result associated with the keyword “flower delivery”, the exposure index computation unit 302 may compute the average click rate with respect to days whose number of exposures is not less than 20.

On the other hand, though M is determined to be 20% of the daily average in the present embodiment, the administrator of the search system 300 may statically or empirically determine how much of the daily average is reflected onto the value of M, such as 10%.

The average click rate computed according to the first method or second method, as described below, is a factor reflected to a process of selecting a search result with respect to the keyword.

Also, as described above, since the average click rate is computed based on a number of exposures, which is a number of times of providing and exposing a search result to a user in association with a predetermined keyword and a click rate that is a ratio of a number of times that the user clicks a predetermined search result, the average click rate reflects user preferences or the degree of association between a keyword and a search result. Also, since the average click rate has a characteristic of a moving average of click rates for several days elapsing immediately before a present point in time, the average click rate has a smaller variance than a click rate for each day computed for each day according to a predetermined search result.

Referring to Table 2 of FIG. 7, a number of exposures with respect to the search result 501 at October 10 is 70 and a click rate is 12, if an average click rate for N days, namely, 5 days, is computed on October 11 according to the second method, a newly computed average click rate is as shown below.

$$\begin{matrix}Newly computed average \\ click rate\end{matrix} = \frac{( \begin{matrix}15.3 + 21.5 + \\ 7.8 + 15 + 12\end{matrix} ) ( times )}{5 ( days )} \approx 14.3$$

Accordingly, comparing to the previously computed average click rate 15.3, with the newly computed average click rate, there is a difference of no more than −1. On the other hand, looking over a number of clicks for each day, in comparison to a click rate of 17 on October 9, a click rate of a previous day, October 10, is 12 and a difference between them is 5.

Accordingly, in comparison with a case of selecting a search result by reflecting a unit period click rate, such as a click rate for each day, in the case a search result is selected by reflecting the average click rate, the possibility of a change in the selected search result becomes decreased.

On the other hand, the exposure index computation unit 302 may periodically compute the average click rate. For example, the average click rate may be computed at 2 am every day.

The exposure index computation unit 302 computes an exposure index for each search result based on the average click rate computed with respect to the search result and a bid amount associated with the search result.

According to an embodiment of the present invention, the exposure index is computed as described below.
Exposure index=average click rate×bid

Also, according to another embodiment of the present invention, the exposure index is computed as described below.
Exposure index=weighted average click rate×weighted bid=(average click rate+a)×(bid+b)

The a is a first weight added to the average click rate, and the b is a second weight added to the bid. According to how to determine the first weight and the second weight, the administrator of the search system 300 may determine whether preference or relation is more strongly reflected or a bid amount is more strongly reflected.

The administrator of the search system 300 may determine the proper a and the b may be determined according to a statistical or empirical method.

The exposure index according to the present embodiment is computed in association with a predetermined keyword, for each search result and based on an average click rate and bid. An average click rate of the search result 501 associated with the keyword “flower delivery” is 15.3, and bid amount presented by an advertiser registering the search result 501 is 950 won. Accordingly, the exposure index with respect to the search result 501 associated with the keyword “flower delivery” is computed as 15.3×950=14535 from average click rate×bid amount.

Accordingly, it may be understood by those skilled in the art that the exposure index varies in the case the advertiser registers the changed bid amount or the average click rate changes. Namely, since the exposure index is computed based on the average click rate, the extent the users prefer the search result 501 is reflected onto the exposure index.

Accordingly, since the advertiser can register the search result 501 with respect to keywords “flower delivery” and “wreaths”, respectively, the exposure index may be computed for each keyword and search result.

Also, the search system 300 may update the exposure index with respect to a predetermined search result associated with a predetermined keyword whenever the bid amount changes or the average click rate changes. Also, the search system 300 may periodically compute the exposure index by considering loads on the system.

(2) A Case of Computing an Exposure Index According to a Second Exposure Index Computation Method

In the case the total exposure number of the search result is less than the reliable exposure number, the exposure index computation unit 302 computes an exposure index based on a bid amount associated with the search result and a predetermined basic click rate.

In the case the total exposure number is less than the reliable exposure number, it is difficult to consider that a click rate with respect to the search result reflects the preference of users. For example, a click rate in which a first search result exposed 100 times is selected 20 times by users is 20%, and a click rate in which a second search result exposed 5 times is selected 1 time by a user is also computed as 20%.

Accordingly, in the case the total exposure number is too small, it is difficult to consider that sufficient amount of data is obtained for reflecting the preference of users. Accordingly, the exposure index computation unit 302 determines that it is not proper to use an average click rate that is a moving average for the certain period of click rates, in the case the total exposure number itself is small, and uses a basic click rate. Namely, in the present invention, the reliable exposure number has the characteristics of a critical value.

The basic click rate may be empirically or experimentally selected by the administrator of the search system 300. Also, according to another embodiment of the present invention, the exposure index computation unit 302 may select the basic click rate for each keyword associated with the search result. In the case of a popular keyword, since a possibility of selecting search results of the keyword, provided according to a search request, by users is high, the more popular keyword, the higher the basic click rate is determined. On the other hand, depending on input frequency of a keyword, it may be determined whether the keyword is popular.

Namely, the exposure index computation unit 302 may compute an exposure index by using a bid amount associated with the search result or a keyword associated with the search result.

According to an embodiment of the present invention, an exposure index is computed as described below.
Exposure index=basic click rate×bid

Also, according to another embodiment of the present invention, an exposure index is computed as described below.
Exposure index=weighted basic click rate×weighted bid=(basic click rate+c)×(bid+d)

The c is a first weight added to the basic click rate, and the d is a second weight added to the bid.

Referring to FIG. 2, the search service providing method according to the present embodiment will be described.

In Step 202, a user transmits a search request with respect to a predetermined keyword to the search system 300. A user input unit 304 of the search system 300 receives the search request. For example, the keyword is “flower delivery”.

In Step 203, a search result selection unit 305 selects a predetermined number of search results whose exposure index is high from search results associated with the keyword with reference to the search result database 301 according to the search request. For example, the search result selection unit 305 may select search results whose exposure index is included in the top 5.

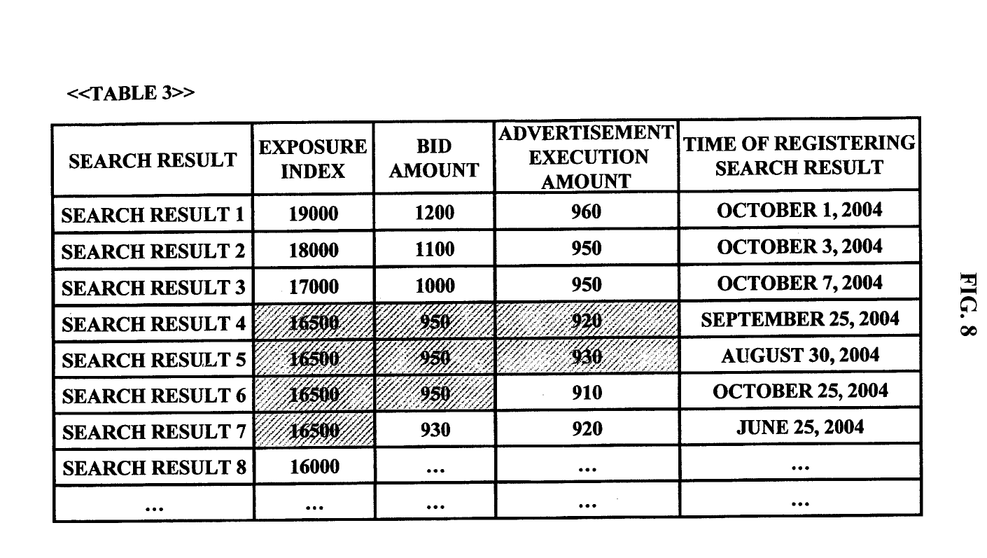

Referring to FIG. 8, if there are 19000, 18000, 17000, 16500, 16200 (in the case of a search result 502), 14535 (in the case of the search result 501), 14000, . . . , five search results whose exposure index is 19000, 18000, 17000, 16500, or 16200 are selected. Accordingly, since the exposure index of the search result 501 is 14535, that is, sixth, the search result 501 is not included in the five search results.

Also, according to another embodiment of the present invention, in the case the search result selection unit 305 cannot select the top five because there are search results whose exposure index is the same, just five search results can be selected by giving precedence as below. In Table 3 of FIG. 8, there is an example of an exposure index, bid amount, advertisement execution amount, and registration time of a search result for each search result associated with the keyword “flower delivery”. In Table 3, a case of arranging the search results according to the exposure index is illustrated.

Because of the search results 4 through 7 whose exposure index is 16500, it is not easy to select the top 5, for the search system 300. Accordingly, the search system 300, according to the present embodiment, gives preference to a search result whose bid amount is high in the case the exposure index is the same.

Referring to Table 3, the search result 7 has a bid amount smaller than the search results 4 through 6 whose exposure index is the same. Accordingly, the search system 300 does not select the search result 7.

On the other hand, since the search results 4 through 6 still have the same priority despite also considering the bid amount, it is not easy to select the top 5 search results, for the search system 300. Accordingly, according to another embodiment of the present invention, with respect to the search results whose exposure index and bid amount are the same, the search system 300 selects the search result by further considering an advertisement execution amount.

As described above, the bid amount indicates a maximum cost that the advertiser intends to pay as an advertisement cost. Actually, an advertisement cost to be charged to the advertiser may be different from the bid amount. In the present specification, an advertisement execution amount indicates an advertisement cost actually charged to the advertiser when the users select a search result. For example, the search system 300 may determine the bid amount to be the advertisement execution amount, or may determine an amount in which a certain amount is added to a bid amount of a search result corresponding to a rank next to the search result to be an advertisement cost.

Also, according to still another embodiment of the present invention, in the case the top five search results still cannot be selected in spite of also considering the exposure index, the bid amount, and the advertisement execution amount, a registration day of the search results is further considered to select an antecedently registered search result.

Accordingly, the search system 300 may determine a predetermined number of search results by considering i) an exposure index, ii) a bid amount with respect to search results whose exposure index is the same, iii) an advertisement execution amount with respect to search results whose exposure index and bid amount are the same, and iv) a search result registration time with respect to search results whose exposure index, bid amount, and advertisement execution amount are the same.

Referring to Table 3 of FIG. 8, with respect to the search results 4 through 7 whose exposure index is the same, the search results 4 through 6 are selected by considering the bid amount. With respect to the search results 4 through 6 whose exposure index and bid amount are the same, the search results 4 and 5 are selected by further considering the advertisement execution amount. Considering the advertisement execution amount, since the top five search results are all selected as the search results 1 through 5, in the case of Table 3, the search system 300 is not required to further consider a search result registration time.

In Step 204, the search result list providing unit 306 generates a search result list including the selected five search results. In Step 205, the search result list providing unit 306 provides the generated search result list to the user by transmitting the search result list to the user terminal 110.

Referring to FIG. 5, in the case of comparing the search result 501 with the search result 502, the search result 502 whose bid amount is low but average click rate is higher is selected to be the search result included in the search result list instead of the search result 501 coming up with a higher bid amount. Accordingly, according to the present embodiment, the advertiser may select i) a method of increasing a bid amount and ii) a method of proposing a bid amount at a certain degree and search results are constructed of forms and contents which are preferred by users so that many of the users may select, such that the search result of the advertiser is included in a search result list to be provided to the users. The bid amount is used as a basis for computing an advertisement execution amount that is an advertisement cost charged to the advertiser in the case each of the search results is clicked by the user. Therefore, for the advertiser, the bid amount cannot be haphazardly increased.

Accordingly, according to the present invention, there are effects of i) providing a search result preferred by users by reflecting a click rate with respect to a search result in selecting the search result, ii) guaranteeing a search result provided whenever a search is requested to not be excessively varied, in this regard by using an average value of unit period click rate for a certain past period instead of a click rate with respect to the search result, and iii) the advertiser's considering not only a bid amount but also quality of a search result in order to increase probability of selecting the advertiser's own search result. Accordingly, according to the present invention, the quality of the search result provided by the search system 300 is increased, thereby increasing preference of users with respect to search services provided by the search system 300. Namely, the users prefer the search services provided by the search system 300 more than other search services.

Also, since an advertiser knowing that the advertiser's own search result is not preferred by users by referring to an average click rate increases a bid amount in order to include the advertiser's own search result in a search result list, an earning rate in the search system 300 may be increased. Particularly, according to the present invention, since the fluctuation in an average click rate is small, an advertiser may estimate at what degree of a bid amount an advertiser's search result can be selected.

On the other hand, though a search request is inputted from the user in Step 202 and the search result selection unit 305 selects a search result in Step 203 in the described embodiment, this is an exemplary example. The search result selection unit 305 may previously select the top 5 search results whose exposure index is high for each keyword in real time or periodically, and may provide the previously selected five search results to a user when a search request of the user is received.

Also, the search result list providing unit 306 may generate a search result list to arrange five search results included in the search result list according to an order of exposure. Also, the search result list providing unit 306 may generate the search result list to arrange the five search results according to a bid amount. Also, the search system 300 may enable the five search results to be newly arranged by using a rolling method whenever the search result list is provided to a user. The present invention relates to a method of selecting a predetermined number of search results included in a search result list, and a method of arranging the selected search result does not limit the scope of the present invention.

Also, the embodiments of the present invention include a computer readable medium including a program instruction for executing various operations realized by a computer. The computer readable medium may include a program instruction, a data file, and a data structure, separately or cooperatively. The program instructions and the media may be those specially designed and constructed for the purposes of the present invention, or they may be of the kind well known and available to those skilled in the art of computer software arts.

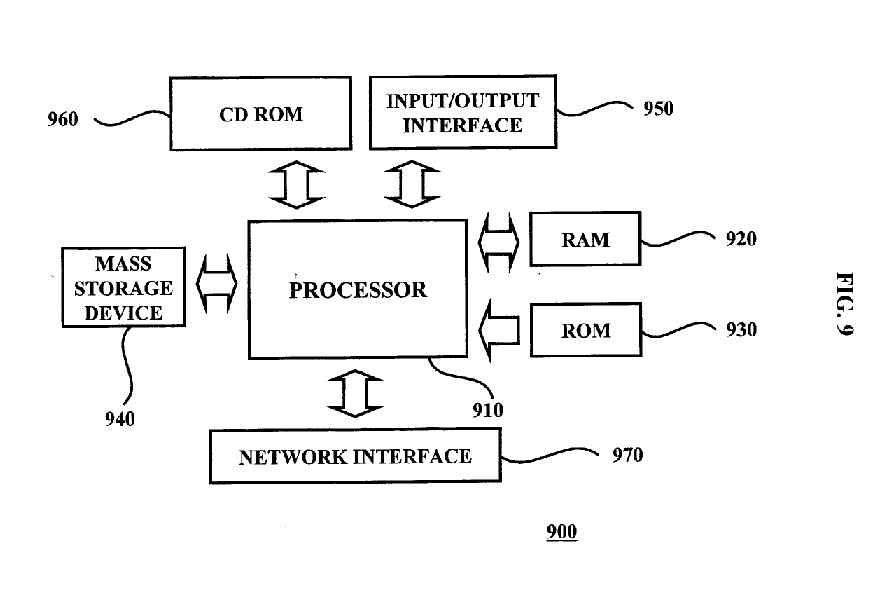

FIG. 9 is an internal block diagram of a general use computer apparatus capable of being employed in performing the search service providing method according to the present invention.

A computer apparatus 900 includes at least one processor 910 connected to a main memory device including a RAM (Random Access Memory) 920 and a ROM (Read Only Memory) 930. The processor 910 is also known as a central processing unit CPU. As well-known to the field of the art, the ROM 930 unidirectionally transmits data and instructions to the CPU, and the RAM 920 is generally used for bidirectionally transmitting data and instructions. The RAM 920 and the ROM 930 may include a certain proper form of a computer readable recording medium. A mass storage device 940 is bidirectionally connected to the processor 910 to provide additional data storage capacity and may be one of the computer readable recording medium. The mass storage device 940 is used for storing programs and data and is an auxiliary memory. A particular mass storage device such as a CD ROM 960 may be used. The processor 910 is connected to at least one input/output interface 950 such as a video monitor, a track ball, a mouse, a keyboard, a microphone, a touch-screen type display, a card reader, a magnetic or paper tape reader, a voice or hand-writing recognizer, a joy stick, and other known computer input/output unit. The processor 910 may be connected to a wired or wireless communication network via a network interface 970. The procedure of the described method can be performed via the network connection. The described devices and tools are well-known to those skilled in the art of computer hardware and software.

The described hardware devices may be formed to be operated by at least one software module in order to perform the operations of the present invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching.

Therefore, it is intended that the scope of the invention be defined by the claims appended thereto and their equivalents.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

According to the present invention, there are provided a search service providing method and search system which select a search result by considering a bid amount associated with a search result and an average click rate computed with respect to the search result.

According to the present invention, there are also provided a search service providing method and search system which select a search result based on a bid amount and an average click rate, thereby guaranteeing quality of a search result provided according to a keyword advertisement service.

According to the present invention, there are also provided a search service providing method and search system which select a search result by using an average click rate whose variance is smaller than a click rate so that an advertiser may estimate what search result is selected.

According to the present invention, there are also provided a search service providing method and search system which provide a basis for determining whether a search result is provided to a user in the case it is difficult to use an average click rate as valid data because the search result is not sufficiently provided to a user from a point in time an advertiser registers the search result to a present point in time or because a period from the point in time the search result is registered to the present point in time is short.

According to the present invention, there are also provided a search service providing method and search system which determine a value of M according to a number of times of inputting a keyword to compute an average click rate and compute an average click rate by reflecting click rate of unit period whose number of exposures, for example, a number of providing a search result, is not less than the value of M, thereby better guaranteeing a smaller variance.

1. A computer-implemented method of providing search result, the method comprising the steps of:
maintaining a database, the database storing a plurality of search listings, wherein each stored search listing is associated with at least one keyword, an advertiser, a bid amount, the number of exposure of the advertising list and an exposure index;
searching the database for search listings corresponding to a keyword in response to a search request received from a searcher,
identifying a predetermined number of search listings having keywords generating a match with the search request, the predetermined number of the search listings being selected based, at least in part, upon the exposure index;
generating a search result list by arranging the identified search listings; and
displaying the generated search result list in response to the search request,
wherein the exposure index is determined based, at least in part, upon the bid amount and an average click rate of each searched advertising list for a first specified time period unless the number of exposure of the advertising list for a second specified time period is less than a predetermined exposure value.

2. The method of claim 1,
wherein the exposure index is determined based at least in part, upon the bid amount and a specified click rate if the number of exposure of the advertising list for the second specified time period is more than the predetermined value.

3. The method of claim 1, wherein:
a predetermined exposure value is determined based at least in palt upon an average value of unit period inputs of a keyword for a third specified time period where the unit period inputs of the keyword is the number of times of searches for the keyword at a predetermined time interval.

4. The method of claim 2, wherein the specified basic click rate is set up for each keyword associated with the search listing.

5. The method of claim 1, wherein:
the exposure index is computed by multiplying the average click rate by the bid amount for each search listing.

6. The method of claim 1, wherein the exposure index is determined by the following steps of:
computing a weighted average click rate by adding a first weight to the average click rate;
computing a weighted bid amount by adding a second weight to the bid amount; and
determining the exposure index by multiplying the weighted average click rate and the weighted bid amount.

7. The method of claim 1, wherein: the first specified time period is determined to be a sum of N period units; and the average click rate is determined by the following steps of:
identifying N of the unit periods whose number of exposures is not less than M in the unit period in an order of closest to the present point in time, for each of the search listing;
adding the unit period click rates with respect to the identified N unit periods; and
computing the average click rate of the first specified time period by dividing the added click rate by the first specified time period.

8. The method of claim 7, wherein the identifying N of the unit periods whose number of exposures is not less than M in the unit period in the order of closest to the present point in time, for each of the search listings comprises the steps of:
computing an average of input numbers for a second period, the input number being a number of times of inputting the keyword associated with the search listing by the users; and
determining a value of M as a proportion of the computed average of the input number.

9. The method of claim 1, wherein the average click rate is an average value of unit period click rates for the first specified time period and each of the unit period click rates is determined at a predetermined time interval.

10. A computer readable recording medium in which a program for executing the method recited in claim 1.

11. A search system providing search service, comprising:
a database, the database storing a plurality of search listings, wherein each stored search listing is associated with at least one keyword an advertiser, a bid amount the number of exposure of the advertising list, and an exposure index;
an exposure index computation unit for computing an average click rate for each of the search listings;
a database management unit configured for recording the exposure index in the search result database in association with the search listing to be updated;
a search listing selection unit configured for selecting a predetermined number of search listings having keywords generating a match with the search request, the predetermined number of the search listings being selected based, at least in part, upon the exposure index; and
a search result list providing unit configured for generating a search result list by arranging the selected search listings and for providing the search result list to the user,
wherein the exposure index is determined based, at least in part upon the bid amount and an average click rate of each searched advertising list for a first specified time period unless the number of exposure of the advertising list for a second specified time period is less than a predetermined exposure value.

12. The system of claim 11, wherein
the exposure index is determined based, at least in part, upon the bid amount and a specified click rate if the number of exposure of the advertising list for the second specified time period is more than the predetermined value.

13. The system of claim 11, wherein a predetermined exposure value is determined based, at least in part, upon an average value of unit period inputs of a keyword for a third specified time period where the unit period inputs of the keyword is the number of times of searches for the keyword at a predetermined time interval.

14. The system of claim 11, wherein the specified basic click rate is set up for each keyword associated with the search listing.

15. The system of claim 11, wherein:
the exposure index is computed by multiplying the average click rate by the bid amount for each search listing.
